(19) United States
(12) Patent Application Publication
(10) Pub. No.: US 2016/0012150 A1
(43) Pub. Date: Jan. 14, 2016

(54) SYSTEM AND METHOD FOR MAIN DISTRIBUTION NETWORK GRAPH/MODEL/DATA INTEGRATION BASED ON REMOTE ACCESS AND INFORMATION INTERACTION

(71) Applicants: STATE GRID CORPORATION OF CHINA, Beijing (CN); STATE GRID JIANGSU ELECTRIC POWER COMPANY, Nanjing, Jiangsu Province (CN); STATE GRID SUZHOU POWER SUPPLY COMPANY, Suzhou, Jiangsu Province (CN); CHINA ELECTRIC POWER RESEARCH INSTITUTE, Beijing (CN); NARI TECHNOLOGY CO., LTD., Nanjing, Jiangsu Province (CN)

(72) Inventors: Bing HAN, Suzhou, Jiangsu Province (CN); Songhua RUI, Suzhou, Jiangsu Province (CN); Jianguo YAO, Beijing (CN); Jiaqing ZHAO, Suzhou, Jiangsu Province (CN); Hongwei DU, Nanjing, Jiangsu Province (CN); Kejun QIAN, Suzhou, Jiangsu Province (CN); Haibing ZHU, Nanjing, Jiangsu Province (CN); Zemei DAI, Nanjing, Jiangsu Province (CN); Weijin ZHUANG, Beijing (CN); Tao HAN, Nanjing, Jiangsu Province (CN); Yang LV, Suzhou, Jiangsu Province (CN); Jiang TIAN, Suzhou, Jiangsu Province (CN)

(21) Appl. No.: 14/414,673

(22) PCT Filed: Dec. 16, 2014
(86) PCT No.: PCT/CN2014/094004

§ 371 Date: Jan. 13, 2015

(30) Foreign Application Priority Data
Jul. 11, 2014 (CN) 201410330692.6

(51) Int. Cl. G06F 17/30; G06Q 50/06

(52) U.S. Cl. CPC G06F 17/30958; G06Q 50/06

(57) ABSTRACT

The present invention discloses a system and a method for main distribution network graph/model/data integration based on remote access and information interaction. The system integrates graph information, model information, and real-time data of a main power transmission and transformation system into an application system by using processing methods such as remote access, SVG graphic file import, CIM model file import, an event service mechanism, and a message mechanism, to minimize mutual information dependence when the application system imports the model information, the graph information, and the real-time data in the main network power transmission and transformation system.

### BACKGROUND

1. Technical Field

The present invention relates to a system for main distribution network graph/model/data integration based on remote access and information interaction, and also relates to a method for main distribution network graph/model/data integration implemented based on the system, which pertains to the field of power distribution network technologies.

2. Related Art

With rapid economic and technological development, people have become increasingly demanding on electric power. To better serve users, various application systems that serve a power network emerge constantly. Functions of many application systems, especially application systems related to a power distribution network, usually need graph/model/data information in a main network power transmission and transformation system, and the graph/model/data information in the main network power transmission and transformation system needs to be integrated into the application systems.

In an existing main network power transmission and transformation system, a system for graph/model/data integration needs manual maintenance and check of pre-channel information and point number information of all real-time data, which has great workload; moreover, only a plant station graph of the main network can be imported and the graph imported is of a single type; the import of graph information and real-time data in the main network power transmission and transformation system completely depends on model information in the main network power transmission and transformation system. The problems bring about great inconvenience to users during use of the application systems.

### SUMMARY

The technical problem to be solved by the present invention is to provide a system and a method for main distribution network graph/model/data integration based on remote access and information interaction, so as to reduce mutual information dependence among model information, graph information, and real-time data of a main network power transmission and transformation system during import.

To solve the problem, a technical solution adopted by the present invention is as follows:

A system for main distribution network graph/model/data integration based on remote access and information interaction, including an application system, where the application system includes a data center, a database, a main network power transmission and transformation system graph import unit, a main network power transmission and transformation system model import unit, and a main network power transmission and transformation system real-time data import unit;

the data center includes a functional module, an interface server, and a hardware server for implementing main network graph/model/data integration in the application system; the data center centralizes graph/model/data information of a main network power transmission and transformation system into the data center by using the main network power transmission and transformation system graph import unit, the main network power transmission and transformation system model import unit, and the main network power transmission and transformation system real-time data import unit, and the graph/model/data information is processed by the data center and then updated into the database of the application system;

for a main network power transmission and transformation system that supports the remote access, the main network power transmission and transformation system graph import unit has free access to graph information in the main network power transmission and transformation system by using a remote access interface, to implement virtual import of the graph information of the main network power transmission and transformation system; for a main network power transmission and transformation system that does not support the remote access, the main network power transmission and transformation system exports an SVG graphic file, and the main network power transmission and transformation system graph import unit generates according to an IEC 61970 standard, in the application system, graph information described in the SVG graphic file and stores the graph information into the database;

for a CIM model file exported from the main network power transmission and transformation system, the main network power transmission and transformation system model import unit establishes, according to the IEC 61970 standard, a correspondence between respective CIM classes and attributes thereof in the CIM model file and a data table in the database of the application system, parses the CIM model file, and stores model information into a corresponding data table;

for a main network power transmission and transformation system that supports an event service mechanism, the main network power transmission and transformation system real-time data import unit updates real-time data that changes in the main network power transmission and transformation system into the database of the application system by using the event service mechanism; and for a main network power transmission and transformation system that does not support the event service mechanism, the main network power transmission and transformation system real-time data import unit parses a message in the main network power transmission and transformation system and stores, according to a measurement keyword in the model information, real-time data in the message into the database of the application system.

A method for main distribution network graph/model/data integration based on remote access and information interaction, implemented based on the system for main distribution network graph/model/data integration, including:

centralizing graph/model/data information of a main network power transmission and transformation system into a data center and determining, by the data center, a type of information to be imported;

when the information to be imported is graph information, determining, by the data center, whether the main network power transmission and transformation system supports the remote access, if the main network power transmission and transformation system supports the remote access, virtually importing, by the data center, the graph information into an interface buffer of an application system by using a main network power transmission and transformation system graph import unit, and if the main network power transmission and transformation system does not support the remote access, importing, by the data center, the graph information into a database of the application system by using the main network power transmission and transformation system graph import unit;

when the information to be imported is model information, importing, by the data center, the model information into the database of the application system by using a main network power transmission and transformation system model import unit;

when the information to be imported is real-time data, updating, by the data center, real-time data that changes into the database of the application system by using a main network power transmission and transformation system real-time data import unit; and

returning image data back to a man-machine of the application system according to a refresh cycle.

The system and the method for main distribution network graph/model/data integration based on remote access and information interaction provided in the present invention solves the following problems, such as the import of graph information and real-time data in a main network power transmission and transformation system completely depends on model information in the main network power transmission and transformation system, only a plant station graph of the main network can be imported and the graph imported is of a single type, information of a channel and a point number needs to be maintained, and the workload is very large, reduces mutual information dependence among model information, graph information, and real-time data in the main network power transmission and transformation system during import, increases the type of importable graphs, decreases information that needs to be manually maintained, and greatly lessens the user's workload.

### BRIEF DESCRIPTION OF THE DRAWINGS

The disclosure will become more fully understood from the detailed description given herein below for illustration only, and thus are not limitative of the disclosure, and wherein:

FIG. 1 is a schematic structural diagram of a system for main distribution network graph/model/data integration based on remote access and information interaction; and

FIG. 2 is a physical structural diagram of remote access and information interaction.

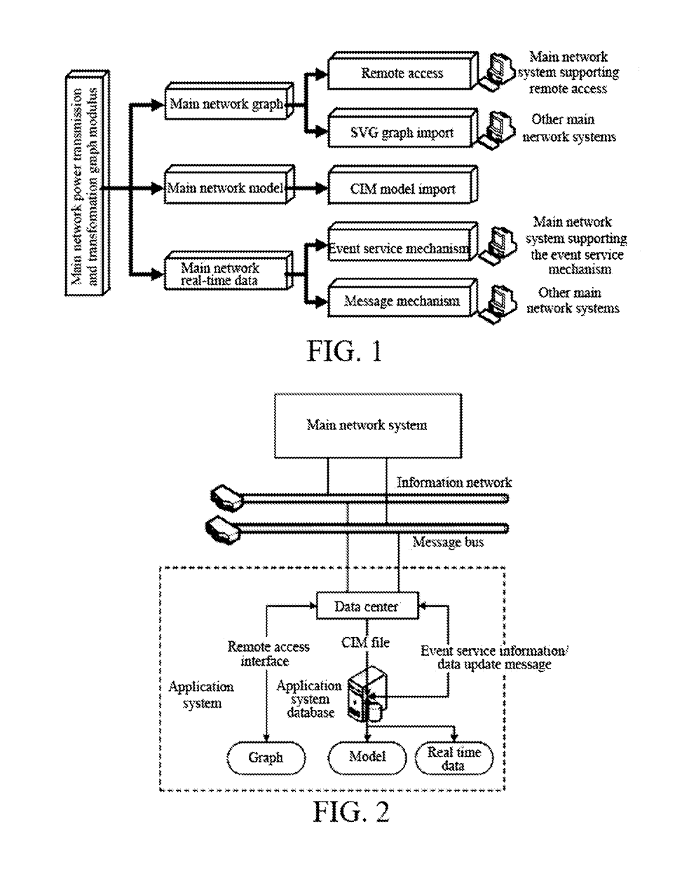

### DETAILED DESCRIPTION

The following further describes the present invention with reference to the accompanying drawings. The embodiments below are only used for more clearly illustrating the technical solution of the present invention, but cannot be used for limiting the protection scope of the present invention.

The system for main distribution network graph/model/data integration based on remote access and information interaction provided in the present invention is applicable to all application systems that need to integrate graph/model/data information in a main network power transmission and transformation system. The system includes a data center, a database, a main network power transmission and transformation system graph import unit, a main network power transmission and transformation system model import unit, and a main network power transmission and transformation system real-time data import unit. The system is specifically described as follows:

(1) Data Center

The data center includes a functional module, an interface server, and a hardware server for implementing main network graph/model/data integration in an application system. The data center centralizes graph/model/data information of a main network power transmission and transformation system into the data center by using the main network power transmission and transformation system graph import unit, the main network power transmission and transformation system model import unit, and the main network power transmission and transformation system real-time data import unit. The data center implements virtual import of graph information between the application system and the main network power transmission and transformation system by using a remote access interface and a graph access buffer, and imports model information by importing a CIM model file that is exported from the main network power transmission and transformation system into a database of the application system and updates real-time data that changes in the main network power transmission and transformation system into the database of the application system by using an event service mechanism, or parses a message in the main network power transmission and transformation system and stores, according to a measurement keyword in the model information, real-time data in the message into the database of the application system, to import the real-time data, so as to implement graph/model/data integration between the application system and the main network power transmission and transformation system.

(2) Main Network Power Transmission and Transformation System Graph Import Unit

For a main network power transmission and transformation system that supports the remote access, the main network power transmission and transformation system graph import unit can have free access to graph information in the main network power transmission and transformation system by using a remote access interface, so as to implement virtual import of the graph information in the main network power transmission and transformation system. Herein, the graph information to which the main network power transmission and transformation system can have access includes various graph information in the main network power transmission and transformation system such as a plant station graph, a contact graph, and a power flow graph. Model information associated with the accessed graph information is model information of a remote main network power transmission and transformation system and does not depend on a local database of the system.

A remote access method includes the following steps:

1) the application system sends a remote access request for graph information;

2) the data center receives the remote access request and forwards the remote access request to the remote main network power transmission and transformation system by using a message bus through a protocol;

3) the remote main network power transmission and transformation system receives the remote access request and sends an interface file required by the request to the application system; and

4) the application system receives the interface file, stores the interface file into an interface buffer, and returns image data back to a man-machine of the application system according to a refresh cycle.

For a main network power transmission and transformation system that does not support the remote access, the main network power transmission and transformation system exports an SVG graphic file, and the main network power transmission and transformation system graph import unit generates according to an IEC 61970 standard, in the application system, graph information described in the SVG graphic file. If model information in the main network power transmission and transformation system has been imported into the application system, the graph information can be associated with the model information in the main network power transmission and transformation system imported into the application system by using a model keyword.

(3) Main Network Power Transmission and Transformation System Model Import Unit

For a CIM model file exported from the main network power transmission and transformation system, the main network power transmission and transformation system model import unit establishes, according to the IEC 61970 standard, a correspondence between respective CIM classes and attributes thereof in the CIM model file and a data table in a database of the application system, parses the CIM model file, and stores model information into a corresponding data table, so as to implement import of the model information in the main network power transmission and transformation system.

(4) Main Network Power Transmission and Transformation System Real-Time Data Import Unit

For a main network power transmission and transformation system that supports an event service mechanism, the main network power transmission and transformation system real-time data import unit imports real-time data in the main network power transmission and transformation system by using the event service mechanism, which includes the following steps:

1) when the real-time data in the main network power transmission and transformation system changes, the main network power transmission and transformation system generates the real-time data that changes into event information and sends the event information to an information network;

2) the data center monitors the information network in real time, and when discovering the event information indicating that the real-time data changes, obtains the event information, converts the event information into an event message in the application system, and sends the event message to the application system; and

3) the application system obtains the event message sent by the data center and updates corresponding data in the database.

For a main network power transmission and transformation system that does not support the event service mechanism, the main network power transmission and transformation system real-time data import unit imports real-time data in the main network power transmission and transformation system by using a message mechanism, which includes the following steps:

1) when the real-time data in the main network power transmission and transformation system changes, the main network power transmission and transformation system forms the real-time data that changes into a message and sends the message to the data center by using a message bus;

2) the data center receives the message sent by the main network power transmission and transformation system, extracts model information and information of a data value and a data state from the message to form a message of the application system, and sends the message to the application system;

3) the application system receives the message sent by the data center, parses the model information, the data value, and the data state in the message, and stores the data value and the data state obtained by parsing into a corresponding record in the database.

A distribution automation system (DAS) is taken as a specific embodiment to specifically describe the present invention as follows:

When graph/model/data integration is performed between the distribution automation system and a main network D5000 system, a system for main distribution network graph/model/data integration based on remote access and information interaction is adopted. Depending on a data center in the distribution automation system, a main network power transmission and transformation system graph import unit adopts a remote access manner to implement virtual import of graph information in a main network power transmission and transformation system by using a remote access interface. A user can have free access to all graph information in the main network power transmission and transformation system such as latest plant station graph, contact graph, and power flow graph. The system for main distribution network graph/model/data integration based on remote access and information interaction does not depend on a local database of the distribution automation system and does not need to maintain graph information imported locally along with a change of the graph information in the main network power transmission and transformation system. The user does not need to maintain any information. The user's workload is minimized.

When graph/model/data integration is performed between the distribution automation system and a main network D5000 system, a system for main distribution network graph/model/data integration based on remote access and information interaction is adopted. When model information of a main network power transmission and transformation system is imported depending on a data center in the distribution automation system, the main network power transmission and transformation system model import unit imports, according to the IEC 61970 standard, a CIM model file exported from the main network power transmission and transformation system into a database of the distribution automation system. The system for main distribution network graph/model/data integration based on remote access and information interaction can only import model information needed by a function of the distribution automation system, unlike an existing integration system, which imports all model information needed in graph information into the distribution automation system so as to enable the imported graph information to be completely displayed. The system reduces the import of redundant model information and lessens the workload of import and maintenance.

When graph/model/data integration is performed between the distribution automation system and a main network D5000 system, a system for main distribution network graph/model/data integration based on remote access and information interaction is adopted. When real-time data in a main network power transmission and transformation system is imported depending on a data center in the distribution automation system, an event service mechanism is used. The main network power transmission and transformation system generates real-time data that changes into event information and sends the event information to an information network, and the distribution automation system monitors the event information in the information network by using the data center, discovers latest real-time data in the main network power transmission and transformation system, and updates corresponding data in the database. The system for main distribution network graph/model/data integration based on remote access and information interaction enables the real-time data integration between the distribution automation system and the main network D5000 system to be the same as integration between a main network power transmission and transformation system work station and a server, which does not require manual maintenance and check of a large volume of pre-channel information and point number information of all real-time data and greatly reduces the user's workload; moreover, the real-time data integration of the main network power transmission and transformation system is no longer implemented by using a front server, thereby reducing processing pressure of the front server.

When graph/model/data integration is performed between the distribution automation system and another main network power transmission and transformation system that does not support the event service mechanism, a system for main distribution network graph/model/data integration based on remote access and information interaction is adopted. When real-time data in the main network power transmission and transformation system is imported depending on a data center in the distribution automation system, real-time data that changes in the main network power transmission and transformation system is formed into a message by using a message mechanism, and the message is sent to the data center by using a message bus; the data center receives the message sent by the main network power transmission and transformation system, converts the message into a message required by the distribution automation system, and sends the message to the distribution automation system; the distribution automation system receives the message sent by the main network power transmission and transformation system, parses model information, a data value, and a data state in the message, and stores the model information, the data value, and the data state into a database. The system for main distribution network graph/model/data integration based on remote access and information interaction only depends on a measurement keyword in the model information, and the measurement keyword may be automatically imported into the database when the model information in the main network power transmission and transformation system is imported, which does not require manual maintenance and check of a large volume of pre-channel information and point number information of all real-time data and greatly reduces the user's workload. Moreover, the system for main distribution network graph/model/data integration based on remote access and information interaction performs message transmission by using the message bus and no longer needs to implement message transmission by using a front server, thereby reducing processing pressure of the front server.

The foregoing content displays and describes the basic principles, main features, and advantages of the present invention. Persons skilled in the art should understand that: the present invention is not limited by the aforementioned embodiments and the content described in the embodiments and specification is only used to describe the principles of the present invention. Various variations and improvements can also be made to the present invention without departing the spirit and scope of the present invention, and these variations and improvements all fall within the protection scope of the present invention. The protection scope of the present invention is defined by the appended claims and the equivalents thereof.

1. A system for main distribution network graph/model/data integration based on remote access and information interaction, comprising an application system, wherein the application system comprises a data center, a database, a main network power transmission and transformation system graph import unit, a main network power transmission and transformation system model import unit, and a main network power transmission and transformation system real-time data import unit, wherein:
the data center comprises a functional module, an interface server, and a hardware server for implementing main network graph/model/data integration in the application system; the data center centralizes graph/model/data information of a main network power transmission and transformation system into the data center by using the main network power transmission and transformation system graph import unit, the main network power transmission and transformation system model import unit, and the main network power transmission and transformation system real-time data import unit, and the graph/model/data information is processed by the data center and then updated into the database of the application system;
for a main network power transmission and transformation system that supports the remote access, the main network power transmission and transformation system graph import unit has free access to graph information in the main network power transmission and transformation system by using a remote access interface, to implement virtual import of the graph information in the main network power transmission and transformation system; for a main network power transmission and transformation system that does not support the remote access, the main network power transmission and transformation system exports an SVG graphic file, and the main network power transmission and transformation system graph import unit generates according to an IEC 61970 standard, in the application system, graph information described in the SVG graphic file and stores the graph information into the database;
for a CIM model file exported from the main network power transmission and transformation system, the main network power transmission and transformation system model import unit establishes, according to the IEC 61970 standard, a correspondence between respective CIM classes and attributes thereof in the CIM model file and a data table in the database of the application system, parses the CIM model file, and stores model information into a corresponding data table;
for a main network power transmission and transformation system that supports an event service mechanism, the main network power transmission and transformation system real-time data import unit updates real-time data that changes in the main network power transmission and transformation system into the database of the application system by using the event service mechanism; and for a main network power transmission and transformation system that does not support the event service mechanism, the main network power transmission and transformation system real-time data import unit parses a message in the main network power transmission and transformation system and stores, according to a measurement keyword in the model information, real-time data in the message into the database of the application system.

2. The system for main distribution network graph/model/data integration according to claim 1, wherein:
the main network power transmission and transformation system graph import unit has free access to the graph information in the main network power transmission and transformation system such as a plant station graph, a contact graph, and a power flow graph by using the remote access interface, to implement virtual import of the graph information in the main network power transmission and transformation system.

3. The system for main distribution network graph/model/data integration according to claim 1, wherein:
when the main network power transmission and transformation system real-time data import unit adopts the event service mechanism, the real-time data in the main network power transmission and transformation system changes, and the main network power transmission and transformation system generates the real-time data that changes into event information and sends the event information to an information network; the data center monitors the information network in real time, and when discovering the event information indicating that the real-time data changes, obtains the event information, converts the event information into event information in the application system, and sends the event information to the application system; and the application system obtains the event information sent by the data center and updates corresponding data in the database.

4. The system for main distribution network graph/model/data integration according to claim 1, wherein:
when the main network power transmission and transformation system real-time data import unit adopts a message service mechanism, power transmission and transformation real-time data in the main network power transmission and transformation system changes, the main network power transmission and transformation system forms the real-time data that changes into a message and sends the message to the data center by using a message bus; the data center receives the message sent by the main network power transmission and transformation system, extracts the model information and information of a data value and a data state from the message to form a message of the application system, and sends the message to the application system; and the application system receives the message sent by the data center, parses the model information and the information of the data value and the data state in the message, and stores the data value and the data state obtained by parsing into a corresponding record in the database.

5. A method for main distribution network graph/model/data integration based on remote access and information interaction, implemented based on the system for main distribution network graph/model/data integration according to claim 1, comprising:
centralizing graph/model/data information of a main network power transmission and transformation system into a data center and determining, by the data center, a type of information to be imported;
when the information to be imported is graph information, determining, by the data center, whether the main network power transmission and transformation system supports remote access, if the main network power transmission and transformation system supports the remote access, virtually importing, by the data center, the graph information into an interface buffer of an application system by using a main network power transmission and transformation system graph import unit, and if the main network power transmission and transformation system does not support the remote access, importing, by the data center, the graph information into a database of the application system by using the main network power transmission and transformation system graph import unit;
when the information to be imported is model information, importing, by the data center, the model information into the database of the application system by using a main network power transmission and transformation system model import unit;
when the information to be imported is real-time data, updating, by the data center, real-time data that changes into the database of the application system by using a main network power transmission and transformation system real-time data import unit; and
returning image data back to a man-machine of the application system according to a refresh cycle.

6. The method for main distribution network graph/model/data integration according to claim 5, wherein the if the main network power transmission and transformation system supports the remote access, virtually importing, by the data center, the graph information into an interface buffer of an application system by using a main network power transmission and transformation system graph import unit comprises:
S11: sending, by the application system, a remote access request for graph information;
S12: receiving, by the data center, the remote access request and forwarding the remote access request to a remote main network power transmission and transformation system by using a message bus through a protocol;
S13: receiving, by the remote main network power transmission and transformation system, the remote access request and sending an interface file required by the request to the application system; and
S14: receiving, by the application system, the interface file and storing the interface file into the interface buffer.

7. The method for main distribution network graph/model/data integration according to claim 5, wherein the if the main network power transmission and transformation system does not support the remote access, importing, by the data center, the graph information into a database of the application system by using the main network power transmission and transformation system graph import unit comprises:
for a main network power transmission and transformation system that does not support the remote access, exporting, by the main network power transmission and transformation system, an SVG graphic file, generating, by the main network power transmission and transformation system graph import unit according to an IEC 61970 standard, in the application system, graph information described in the SVG graphic file, and storing the graph information into the database.

8. The method for main distribution network graph/model/data integration according to claim 5, wherein the importing, by the data center, the model information into the database of the application system by using a main network power transmission and transformation system model import unit comprises:
firstly, for a CIM model file exported from the main network power transmission and transformation system, establishing, by the main network power transmission and transformation system model import unit according to the IEC 61970 standard, a correspondence between respective CIM classes and attributes thereof in the CIM model file and a data table in the database of the application system; then, parsing the CIM model file; and finally, storing the model information into a corresponding data table.

9. The method for main distribution network graph/model/data integration according to claim 5, wherein:
when the model information of the main network power transmission and transformation system has not been imported into the application system, model information associated with the graph information is model information of a remote main network power transmission and transformation system and does not depend on a local database of the application system; and when the model information of the main network power transmission and transformation system has been imported into the application system, the graph information is associated with the model information of the main network power transmission and transformation system imported into the application system by using a model keyword.

10. The method for main distribution network graph/model/data integration according to claim 5, comprising:
when the information to be imported is real-time data, determining, by the data center, whether the main network power transmission and transformation system supports an event service mechanism; if the main network power transmission and transformation system supports the event service mechanism, updating the real-time data that changes into the database of the application system by using the event service mechanism; and if the main network power transmission and transformation system does not support the event service mechanism, updating the real-time data that changes into the database of the application system by using a message mechanism.

11. The method for main distribution network graph/model/data integration according to claim 10, wherein the if the main network power transmission and transformation system supports the event service mechanism, updating the real-time data that changes into the database of the application system by using the event service mechanism comprises:
S21: when the real-time data in the main network power transmission and transformation system changes, generating, by the main network power transmission and transformation system, the real-time data that changes into event information and sending the event information to an information network;
S22: monitoring, by the data center, the information network in real time, and when discovering the event information indicating that the real-time data changes, obtaining the event information, converting the event information into an event message in the application system, and sending the event message to the application system; and
S23: obtaining, by the application system, the event message sent by the data center and updating corresponding data in the database.

12. The method for main distribution network graph/model/data integration according to claim 10, wherein the if the main network power transmission and transformation system does not support the event service mechanism, updating the real-time data that changes into the database of the application system by using a message mechanism comprises:
S31: when the real-time data in the main network power transmission and transformation system changes, forming, by the main network power transmission and transformation system, the real-time data that changes into a message and sending the message to the data center by using a message bus;
S32: receiving, by the data center, the message sent by the main network power transmission and transformation system, extracting model information and information of a data value and data state from the message to form a message of the application system, and sending the message to the application system; and
S33: receiving, by the application system, the message sent by the data center, parsing the model information, the data value, and the data state in the message, and storing the data value and the data state obtained by parsing into a corresponding record in the database.
